(19) United States
(12) Patent Application Publication
(10) Pub. No.: US 2018/0130230 A1
(43) Pub. Date: May 10, 2018

(54) RECOGNITION APPARATUS, DETERMINATION METHOD, AND ARTICLE MANUFACTURING METHOD

(71) Applicant: CANON KABUSHIKI KAISHA, Tokyo (JP)

(72) Inventor: Masaki Nakajima, Utsunomiya-shi (JP)

(21) Appl. No.: 15/792,292

(22) Filed: Oct. 24, 2017

(30) Foreign Application Priority Data
Nov. 8, 2016 (JP) 2016-218160

(51) Int. Cl. G06T 7/73; G06K 9/64

(52) U.S. Cl. CPC G06T 7/74; G06K 9/64

(57) ABSTRACT

A recognition apparatus that recognizes one of the position and the orientation of an object includes an acquisition unit that illuminates the object, images the illuminated object, and acquires image data of the object, and a processing unit that acquires one of the position and the orientation based on a first degree of correlation as a degree of correlation between the image data and reference data related to one of the position and the orientation. The processing unit determines a condition on one of the illumination and the imaging based on a second degree of correlation as a degree of correlation between the image data and the reference data.

### BACKGROUND OF THE INVENTION

### Field of the Invention

The aspect of the embodiments relates to a recognition apparatus, a determination method, and an article manufacturing method.

### Description of the Related Art

A recognition apparatus is known which recognizes the position and the orientation of an object based on an image obtained by imaging the object. A photographing system of Japanese Patent Laid-Open No. 2012-155405 calculates an index (score) indicating whether or not an image is suitable for biometric authentication, based on the area of a region of a living body in the image. An environment used to acquire an image as authentication biometric information and an environment used to acquire an image to detect the orientation of the region of the living body is then switched based on the index.

The photographing system of Japanese Patent Laid-Open No. 2012-155405 simply obtains the index to judge whether or not an image is suitable for biometric authentication, based on the area of a region of a living body. Accordingly, it cannot be said that it is sufficient to recognize the position and the orientation of an object with high accuracy. In a recognition apparatus, a condition on illumination of an object and a condition on imaging of the object can largely influence the recognition of the position and the orientation of the object. For example, if the brightness of the object is not appropriate, the contour and ridge line (edge information) of the object on an image is not clear. Accordingly, it is difficult to recognize the position and the orientation of the object with high accuracy. Moreover, if the object is out of focus, it is also difficult to recognize the position and the orientation of the object with high accuracy.

### SUMMARY OF THE INVENTION

According to one aspect of the embodiments, an apparatus that recognizes one of a position and an orientation of an object includes
an acquisition unit configured to illuminate the object, image the illuminated object, and acquire image data of the object, and
a processing unit configured to acquire the one of the position and the orientation of the object based on a first degree of correlation as a degree of correlation between the image data and reference data of the position and the orientation.

The processing unit determines a condition on one of the illumination and the imaging based on a second degree of correlation as a degree of correlation between the image data and the reference data.

Further features of the disclosure will become apparent from the following description of exemplary embodiments (with reference to the attached drawings).

### BRIEF DESCRIPTION OF THE DRAWINGS

FIG. 1 is a diagram illustrating an example of the configuration of a recognition apparatus.

FIG. 2 is a diagram illustrating the flow of a process in the recognition apparatus.

FIG. 3 is a diagram illustrating the flow of a process of determining conditions.

FIG. 4 is a diagram illustrating a method for inputting the position and the orientation of an object.

FIGS. 5A to 5J are diagrams illustrating pattern light.

FIG. 6 is a diagram illustrating a spatial code.

FIGS. 7A to 7H are diagrams illustrating a state where first and second evaluation values are high.

FIG. 8 is a diagram illustrating another example of the flow of the process of determining the conditions.

FIG. 9 is a diagram illustrating a system including the recognition apparatus and a robot.

### DESCRIPTION OF THE EMBODIMENTS

Embodiments of the disclosure are described hereinafter with reference to the accompanying drawings. The same reference numerals are assigned to the same members and the like through all the drawings for describing the embodiments in principle (unless otherwise noted), and their repeated descriptions are omitted.

### First Embodiment

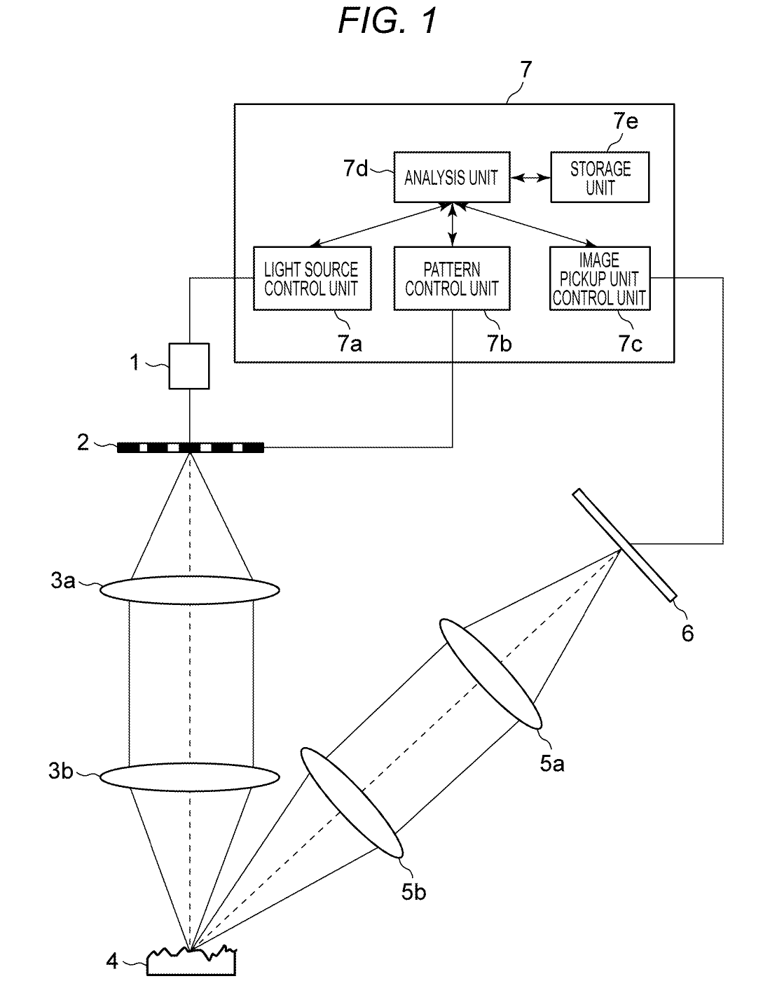

FIG. 1 is a diagram illustrating an example of the configuration of a recognition apparatus. In FIG. 1, a light source 1, a pattern generation unit 2 modulates light from the light source and generates a pattern (light) to be projected onto an object 4, and optical elements (lenses or the like) 3 (3a and 3b) for projecting the pattern light onto the object 4 configure an illumination unit that illuminates the object. Optical elements (lenses or the like) 5 (5a and 5b) that condense the pattern light reflected from the object 4, and an image pickup element 6 that images the object 4 illuminated with the light from the optical elements 5 configure an image pickup unit. Moreover, the above-mentioned illumination unit and image pickup unit configure an acquisition unit. A processing unit 7 can control the emission of light of the light source 1, the generation of the pattern light by the pattern generation unit 2, the time and gain (the degree (level) of amplification of a signal) of imaging (exposure) by the image pickup unit (the image pickup element 6). Moreover, the processing unit 7 can recognize (acquire) at least one of the position and the orientation (attitude) of the object 4 based on image data obtained by imaging with the image capture unit. A recognition target can be at least one of the position and the orientation, but is described in the following description to be (both of) the position and the orientation. The processing unit 7 can include a light source control unit 7a that controls the light source 1 (for example, controls at least one of illuminance intensity and light emission time). Moreover, the processing unit 7 can include a pattern control unit 7b that controls the generation of the pattern light by the pattern generation unit 2. Moreover, the processing unit 7 can include an image pickup unit control unit 7c that controls the image pickup unit (for example, controls at least one of the time and the gain of imaging). Moreover, the processing unit 7 can include a storage unit 7e that stores information on the shape of the object 4 used to recognize the position and the orientation of the object 4. Furthermore, the processing unit 7 can include an analysis unit 7d that recognizes (acquires) the position and the orientation of the object based on the image data and the shape information (reference data).

The recognition apparatus of the embodiment uses, as features, edge information extracted from image data obtained by imaging the object illuminated with substantially uniform light. Moreover, the recognition apparatus uses, as features, distance information extracted from pattern image data obtained by imaging the object illuminated with spatial coding pattern light. The recognition apparatus then recognizes the position and the orientation of the object based on the edge information and the distance information. The distance information may be obtained by using, not limited to illumination with the spatial coding pattern light, but illumination with phase shift pattern light or illumination with slit light. Moreover, the recognition apparatus may recognize the position and the orientation of the object based on only one of the edge information and the distance information, or may recognize the position and the orientation of the object based on other features of the image data.

The light source 1 includes, for example, a light emitting diode (LED) and emits light toward the pattern generation unit 2. The pattern generation unit 2 generates, for example, pattern light where bright portions and dark portions are arranged in a grid pattern (cyclically). The pattern generation unit 2 can include a mask pattern where light transmission portions and light-shielding portions are arranged regularly. Moreover, the pattern generation unit 2 includes a liquid crystal element, a digital mirror device (DMD), or the like, and accordingly can generate various patterns such as a monochrome pattern and a sinusoidal pattern.

The object 4 is illuminated with grid pattern light via the pattern generation unit 2 and the optical elements 3a and 3b. The illuminated object 4 is imaged by the image pickup element 6 via the optical elements 5a and 5b. The image pickup element 6 can include an image pickup element such as a charge coupled device (CCD) or complementary metal oxide semiconductor (CMOS) sensor. The processing unit 7 can be configured of a general-purpose computer including a central processing unit (CPU), memory, a display, an external storage such as a hard disk, and various interfaces for input and output. The light source control unit 7a controls the intensity of light emitted from the light source. The pattern control unit 7b controls the pattern generation unit 2 in such a manner that the pattern light projected onto the object 4 is changed sequentially. The image pickup unit control unit 7c controls at least one of the time and the gain of imaging by the image pickup unit in synchronization with the change of the pattern light. Such control allows the object to be imaged a plurality of times.

The storage unit 7e stores in advance shape data representing the shape of the object 4 such as design data related to the object 4 obtained by computer-aided design (CAD; Computer-aided Design) or measurement data related to the object 4 obtained by shape measurement. The analysis unit 7d acquires edge information related to the contour, ridge line, and the like, and distance information of each portion of the object 4, which are observed when the object 4 is placed in various positions and orientations, based on the shape data and the properties of the optical system included in the acquisition unit. These are then stored in the storage unit 7e as a database of the reference data. The analysis unit 7d then extracts edge information (features) from the image data (the image data related to the substantially uniform illumination) acquired by the image pickup unit. Moreover, the analysis unit 7d extracts (acquires) distance information (features) from the pattern image data (the image data related to the illumination by the pattern projection method) acquired by the image pickup unit. The distance information is extracted also based on information on a geometric relationship between the illumination unit and the image pickup unit in the acquisition unit. The analysis unit 7d calculates (acquires) the degree of correlation or coincidence between the edge information extracted from the image data and the edge information in the database. Moreover, the analysis unit 7d calculates (acquires) the degree of correlation or coincidence between the distance information extracted from the pattern image data and the distance information in the database. The analysis unit 7d then recognizes the position and the orientation of the object 4 based on these degrees of correlation (for example, by searching for reference data where each degree of correlation is the highest). Such a process allows the recognition of the positions and the orientations of objects such as components in random orientations and positions.

Upon recognizing an object as described above, if the prestored reference data and the image data of the object of which position and orientation are to be recognized are significantly different, it is difficult to recognize the position and the orientation. If a recognition target is objects such as a pile of components, the reflection characteristic of light from the surfaces of the objects varies depending on the incident angle of the light. Accordingly, states, such as shapes and brightness, of the objects observed by the recognition apparatus vary. Hence, even if the suitability of image data is judged based on only the area of the objects as in Japanese Patent Laid-Open No. 2012-155405, the positions and the orientations of the objects cannot be always recognized with high accuracy. Hence, a description is given below of a method for determining conditions to acquire image data, which enable the recognition with high accuracy.

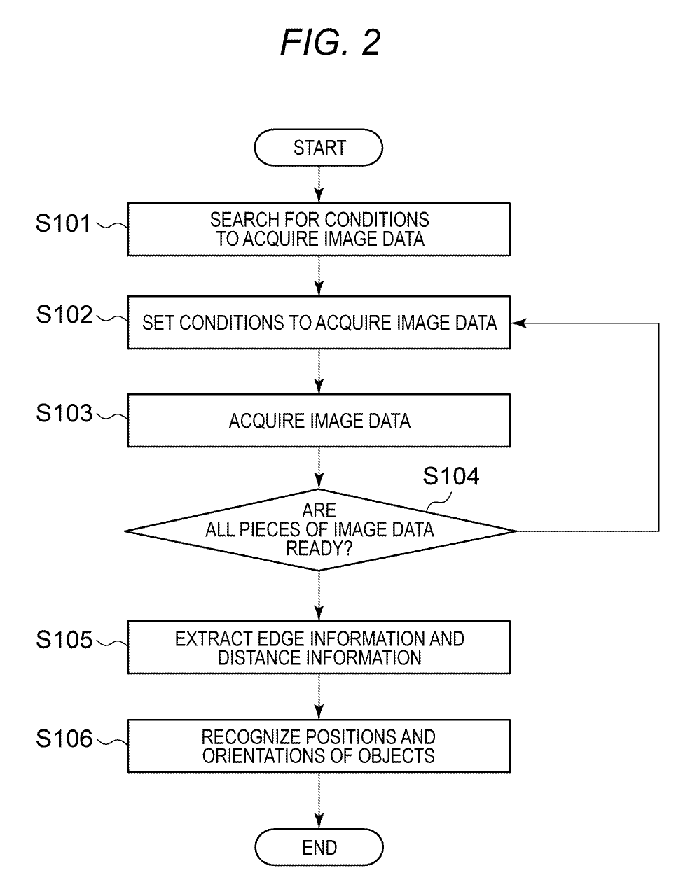

FIG. 2 is a diagram illustrating the flow of a process in the recognition apparatus according to the embodiment. The process is executed by the processing unit 7. Firstly, in step S101, a condition in which a first evaluation value of first image data for obtaining edge information satisfies a tolerance condition, and a condition in which a second evaluation value of second image data for obtaining distance information satisfies a tolerance condition are searched for. For example, the first image data (or the second image data) is acquired according to the condition. The first evaluation value (or the second evaluation value) is acquired (calculated) for each image. The condition in which the first evaluation value (or the second evaluation value) satisfies the tolerance condition (for example, reaches its peak) is searched for. The conditions to acquire image data here include, but are not limited to, at least one of conditions on illumination and imaging of an object to be recognized.

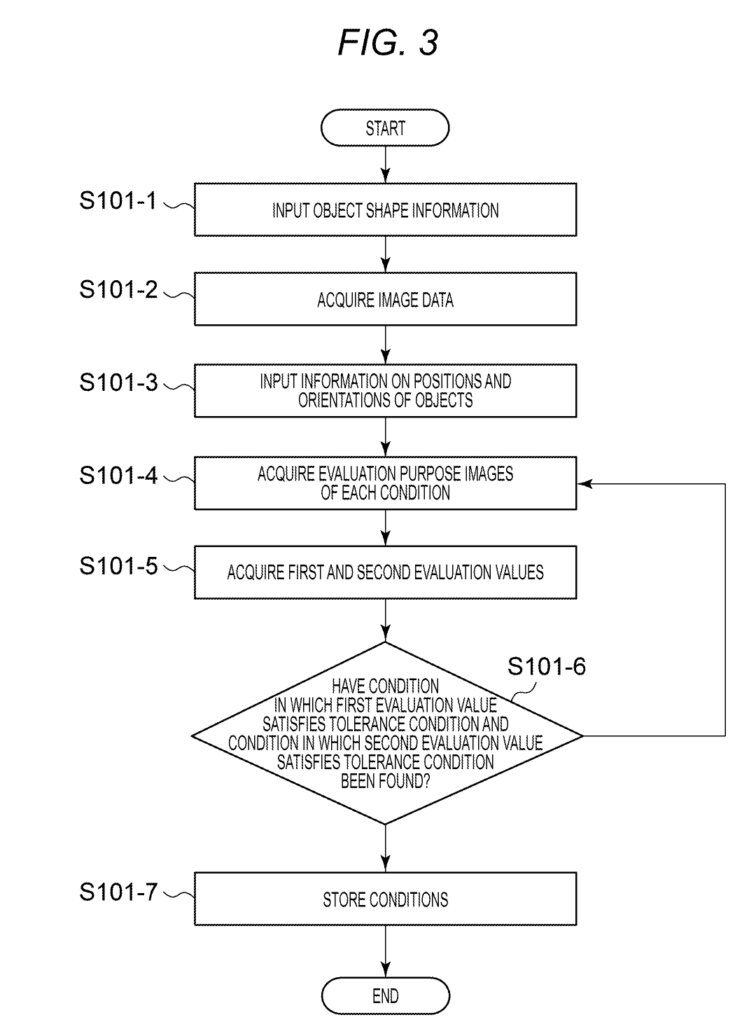

A specific procedure for determining the conditions is illustrated in FIG. 3. FIG. 3 is a diagram illustrating the flow of a process of determining the conditions. Firstly, in step S101-1, the shape information of an object is input. The shape information is, for example, three-dimensional CAD data, but may be measurement data obtained by measuring the object with a three-dimensional measurement device or the like.

Next, in step S101-2, image data of objects (for example, a pile of objects) as a recognition target is acquired. At least one of the intensity of illumination (light), the time of imaging, the amplification (gain) of a signal in imaging can be selected as the condition to acquire an image. However, the condition is not limited to them. For example, a condition related to the focus and zoom of the image pickup unit may be selected. The range of a preset value on the selected condition can be, for example, a range that a human can discriminate objects on the image data. It is effective to perform steps after this step in cases where the state of the pile of objects changes largely. Such cases include a case where the pile of objects has collapsed since a picking robot or the like picked an object, and a case where the height of the pile of objects has changed largely since objects were picked repeatedly.

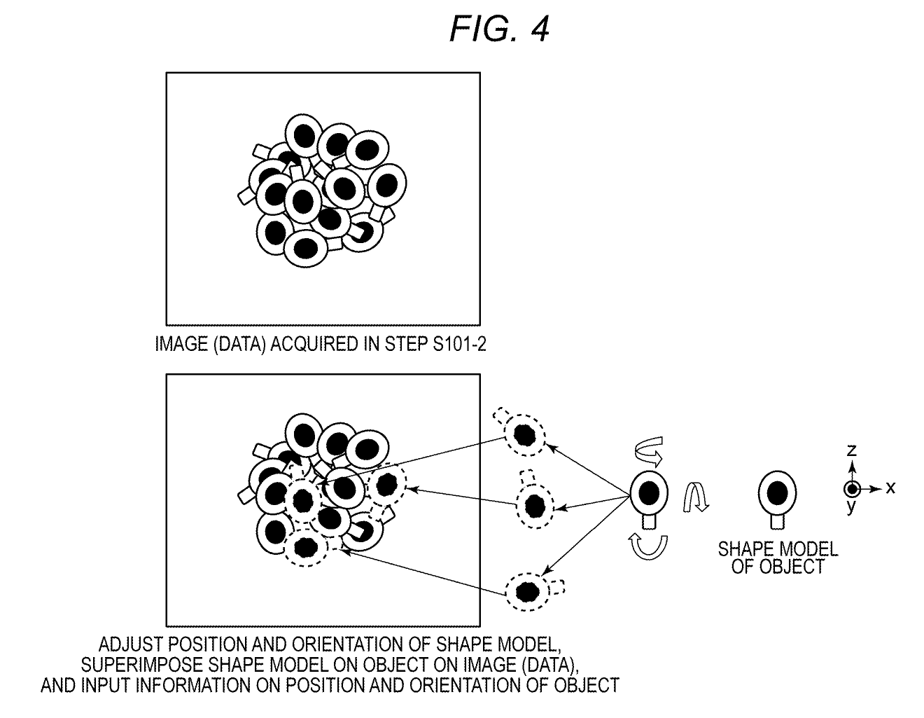

Next, in step S101-3, information on positions and orientations of the objects appearing on (included in) the image data acquired in step S101-2 is input through the operation of an input unit by a user (operator) of the recognition apparatus. The information is used to acquire the first and second evaluation values in step S101-5 below. The number of objects targeted to input the information of the position and orientation is one at minimum. In order to determine a condition to recognize the position and the orientation with higher accuracy, it is desired to input information on the positions and orientations of as many objects in the image data as possible. In order to input the information on the position and orientation, a shape model used to recognize the position and the orientation of the object is generated based on the shape information of the object input in step S101-1. FIG. 4 is a diagram illustrating a method for inputting the position and the orientation of an object. In FIG. 4, an image generated by the shape model is superimposed on the image acquired in step S101-2, and is displayed. The generated image is then adjusted in such a manner that the shape is substantially equal to the shape of the object in the acquired image. The adjustment can be made via a user interface (the input unit) included in the processing unit 7. The position and the orientation of the object are acquired from the shape in the image adjusted with the shape model to enable automatic or manual input in this step.

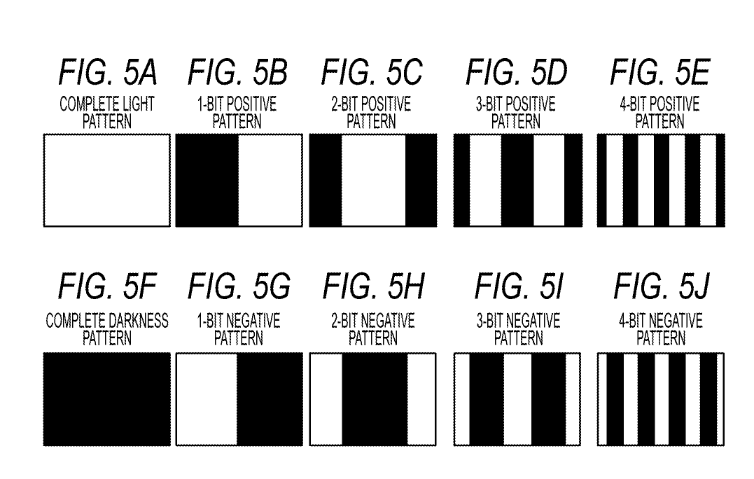

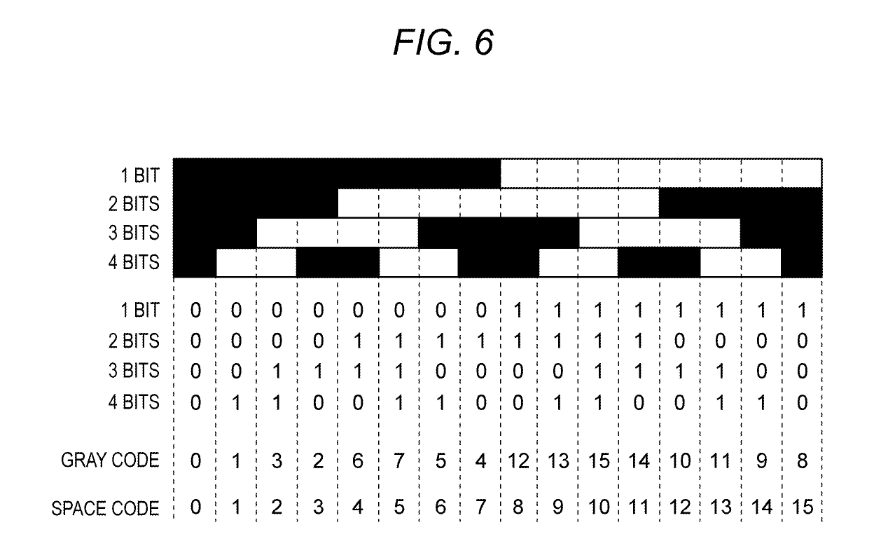

Next, in step S101-4, evaluation purpose images are acquired on each condition. The evaluation purpose images include an image for extracting edge information and an image for extracting (acquiring) distance information (information on the distance to the objects). The image data (the first image data) for extracting edge information is image data obtained by illuminating an entire measurement target area (with substantially uniform light), and imaging the entire measurement target area. Moreover, in the embodiment, the image data (the second image data) for extracting distance information is image data obtained by illuminating with the pattern light according to the spatial coding pattern projection method and capturing an image. The spatial coding pattern projection method illuminates an object with, for example, such strong pattern light (pattern light) as illustrated in FIGS. 5A to 5J. FIGS. 5A to 5J are diagrams illustrating the pattern light. In this example, a four-bit Gray code pattern according to the spatial coding pattern projection method is used (refer to FIG. 6). In terms of the change of the condition, for example, the imaging time is increased to make an image acquired brighter, or vice versa. Moreover, the condition may be changed based on the maximum search algorithm such as the steepest gradient method with the condition in step S101-2 as an initial condition. The condition can be changed to, not limited to, at least one of the intensity of illumination, the time of imaging, and the gain of imaging.

Next, in step S101-5, the degree of correlation (a second degree of correlation) between the edge information (the second image data) extracted from each piece of the image data for edge information extraction acquired in step S101-4, and the prestored edge information (second reference data) of the objects is acquired. Moreover, the degree of correction (the second degree of correlation) between the distance information (the second image data) extracted from each piece of the image data for distance information extraction and the prestored distance information (the second reference data) of the objects is acquired. The degree of correlation is here also called the degree of coincidence. Moreover, the edge information can be extracted with, not limited to, a Canny filter. The evaluation value (the first evaluation value) related to the edge information is, for example, the following one. In other words, the evaluation value (the first evaluation value) is an average of degrees of correlation, L₁, . . . , Lₙ between the edge information (the second image data) extracted from each image and the edge information (the second reference data) obtained from the above shape model based on the position and orientation information input in step S101-3. Here, n is the number of objects of which positions and orientations were input in step S101-3. The evaluation value may be a minimum or sum total of the degrees of correlation, L₁, . . . , Lₙ. The evaluation value (the second evaluation value) related to the distance information is, for example, the following one. In other words, the evaluation value (the second evaluation value) is an average of the inverses (the second degrees of correlation) of differences Δ₁, . . . , Δₙ between Dref₁, . . . , Drefₙ and Dmes₁, . . . , Dmesₙ. Dref₁ to Drefₙ are distances (the second reference data) from the recognition apparatus to the objects obtained from the above shape model based on the information on the positions and the orientations of the objects input in step S101-3. Moreover, Dmes₁ to Dmesₙ are distances to the objects extracted from each image acquired in step S101-4. Δᵢ is represented by the following equation:

Δᵢ=abs(Dmesᵢ−Drefᵢ) (1).

The degree of correlation (the second degree of correlation) used in this step and the degree of correlation (a first degree of correlation) used to recognize the positions and the orientations of the objects in step S105 described below can be different from each other, but may also be the same degree of correlation. Moreover, abs ( ) in equation (1) is a function to output an absolute value of a numerical value inside the parentheses. Moreover, the second evaluation value related to the distance information may be a minimum or sum total of the inverses of Δ₁, . . . , Δₙ.

The distances, Dmes₁ to Dmesₙ, to the objects are acquired from each bit pattern image data acquired in step S101-3. Hence, firstly, light and darkness are determined from the brightness information of the image data, and a spatial code is assigned to each area of the image data. For example, an average of pixel values of row image data is set as a threshold to assign a spatial code to each pixel corresponding between the complete light pattern image data of FIG. 5A and the complete darkness pattern image data of FIG. 5F. In other words, a pixel brighter than the threshold is set at one and a darker pixel at zero. Each bit pattern image data is binarized to enable the generation of spatial codes as illustrated in FIG. 6. The distance Dmes₁ to Dmesₙ from the recognition apparatus to the objects can be acquired based on the spatial codes obtained in this manner and the geometric relationship between the illumination unit and the image pickup unit. When following a phase shift pattern projection method of projecting a sinusoidal pattern where the brightness changes in a sinusoidal form while shifting the phase of the sinusoidal pattern, the phase of each pixel is calculated to enable the acquisition of the distances.

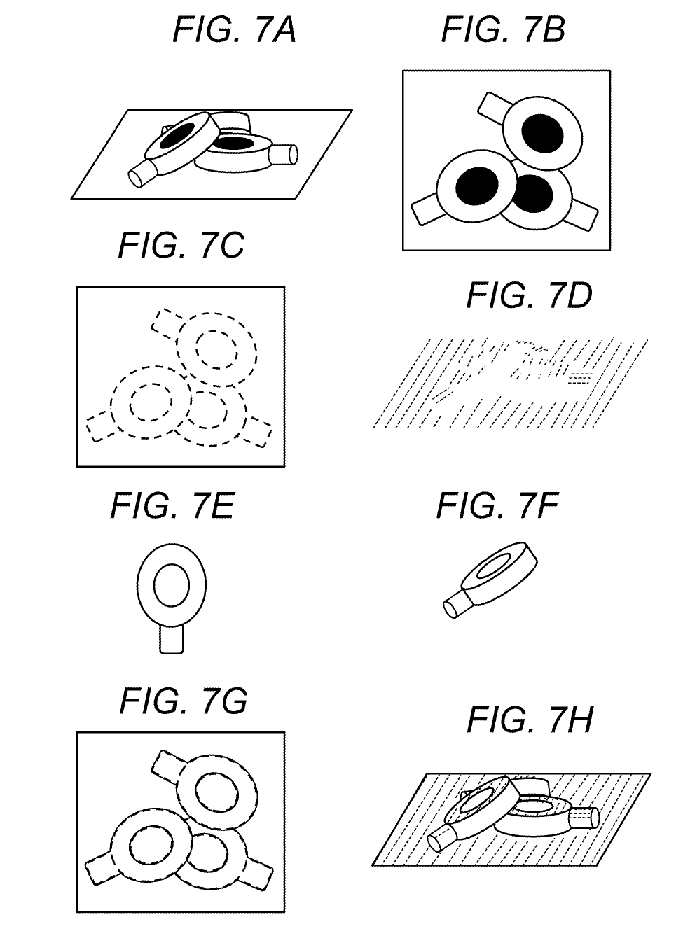

FIGS. 7A to 7H are diagrams illustrating a state where the first and second evaluation values are high. FIG. 7A illustrates objects (such as components) in random orientations and positions. FIG. 7B illustrates image data for edge extraction acquired by imaging the objects. FIG. 7C illustrates edge information extracted from the image data illustrated in FIG. 7B. Moreover, FIG. 7D illustrates distance information extracted (acquired) from pattern image data. The state where the first evaluation value is high is the following state. In other words, it is a state where the edge information extracted from the image data for edge extraction agrees well with edge information of the objects acquired from the prestored shape information (FIG. 7E) based on the information on the positions and the orientations input in step S101-3. For example, it is the state illustrated in FIG. 7G. Moreover, the state where the second evaluation value is high is the following state. In other words, it is the state where the distance information extracted from the image data for distance extraction agrees well with distance information of the objects acquired from the prestored shape information (FIG. 7F) based on the position and orientation information input in step S101-3. For example, it is the state illustrated in FIG. 7H.

Next, in step S101-6, it is judged whether or not the condition in which the first evaluation value satisfies the tolerance condition (for example, reaches its peak) and the condition in which the second evaluation value satisfies the tolerance condition (for example, reaches its peak) could be found. If they could be found, the conditions are stored in step S101-7 to end this search. If they could not be found, steps S101-4 and S101-5 are repeated until the condition in which the first evaluation value satisfies the tolerance condition and the condition in which the second evaluation value satisfies the tolerance condition are found.

Return to FIG. 2 to continue the description of the flow of the process in the recognition apparatus. In step S102, the condition to allow the recognition apparatus to acquire an image is set to the condition in which the first evaluation value satisfies the tolerance condition and the condition in which the second evaluation value satisfies the tolerance condition, which were obtained by the search in step S101. The condition can be at least one of, for example, the intensity of illumination and the time and gain of imaging as described above. When image data for extracting edge information is acquired in step S103, the condition in which the first evaluation value satisfies the tolerance condition is set, and when image data for extracting distance information is acquired, the condition in which the second evaluation value satisfies the tolerance condition is set.

Next, in step S103, the objects are imaged in accordance with the condition set in step S102 to acquire image data. In step S104, it is judged whether or not pieces of image data to acquire the edge information and the distance information in step S105 described below are ready. If so, the process proceeds to step S105. If not, steps S102 and S103 are repeated.

In step S105, the edge information is extracted from the image data for edge extraction acquired in step S103 by using an edge extraction filter such as the Canny filter. Moreover, as described above, the distance information is extracted from the image data for distance extraction through the assignment of spatial codes.

In the following step S106, the positions and the orientations of the objects are recognized based on the edge information and the distance information, which were acquired in step S105. In this manner the process ends.

As described above, in the embodiment, the condition on at least one of illumination and imaging of an object is determined based on the degree of correlation (the second degree of correlation) between (the features of) reference data and (the features of) image data, the degree of correlation (the second degree of correlation) being used to recognize at least one of the position and the orientation of the object. Hence, according to the embodiment, it is possible to provide a recognition apparatus that can determine, for example, a condition on at least one of illumination and imaging of an object, the condition being beneficial to recognize at least one of the position and the orientation of the object.

### Second Embodiment

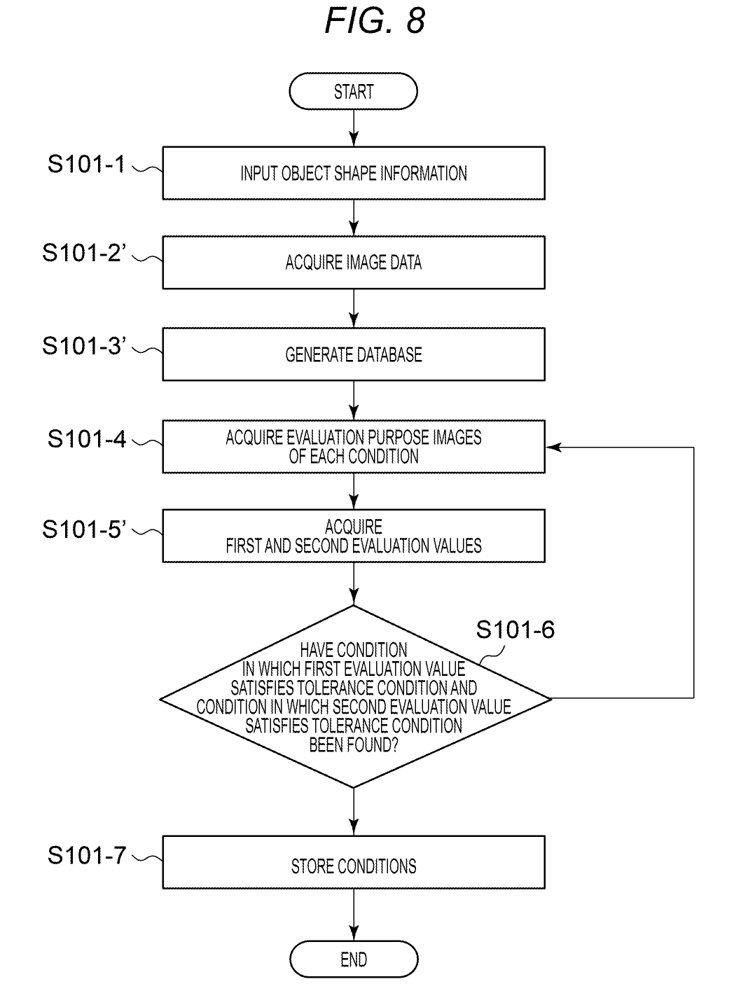

The embodiment is different from the first embodiment in the respect that the position and the orientation of an object are input not through a user's operation of the input unit. In other words, the content of the process in step S101 in FIG. 2 (that is, FIG. 3) is different from the first embodiment. The content is described with reference to FIG. 8. FIG. 8 is a diagram illustrating another example of the flow of the process of determining the conditions. In FIG. 8, what is different from FIG. 3 (the first embodiment) is only steps S101-2′, S101-3′, and S101-5′. Accordingly, these steps are described.

In step S101-2′, image data of objects (for example, a pile of objects) as a recognition target is acquired. In terms of the condition to acquire an image, at least one of the intensity of illumination (light), the time of imaging, and the amplification (gain) of a signal in imaging can be selected. However, the condition is not limited to them. For example, a condition on the focus and zoom of the image pickup unit may be selected. In one embodiment the condition is to be a condition in which an area of the objects in the image data can be acquired as brightly as possible within the range that does not become saturated. Moreover, the number of pieces of image data acquired may be one, or more to increase the robustness of the recognition of the positions and the orientations with a database generated in the next step. If the number of pieces of image data acquired is more than one, when the state of the pile of objects is changed whenever image data is acquired, a database with higher robustness can be created.

Next, in step S101-3′, a database for position and orientation recognition is generated. The database corresponds here to the database of the above-mentioned reference data assuming to be stored in the storage unit 7e in the first embodiment. The database can be generated as the edge information or distance information on an image according to the positions and orientations of the objects in geometric principles based on the shape information of the objects input in step S101-1. This database can be used to recognize the positions and the orientations of the objects in step S105. Moreover, the edge information (the second reference data) of the objects to acquire the second degrees of correlation, L₁ to Lₙ in step S101-5′ described below is extracted as in the extraction in step S105 to be determined and stored here. Similarly, the distance information (the second reference data) of the objects to acquire the inverse of the second degree of correlation, Δ₁, to the inverse of Δₙ in step S101-5′ is extracted as in the extraction in step S105 to be determined and stored here.

In step S101-5′, the degree of correlation (the second degree of correlation) between the edge information or distance information (the second image data) acquired in step S101-4 and the edge information or distance information (the second reference data) of the objects stored in step S101-3′ is acquired. In this step, the process of acquiring the first and second evaluation values can be equivalent to step S101-5 in the first embodiment.

The embodiment has an effect that can reduce the burdens on a user in addition to the effect of the first embodiment, since at least one of the position and the orientation of an object can be input not through a user's operation of the input unit.

### Third Embodiment

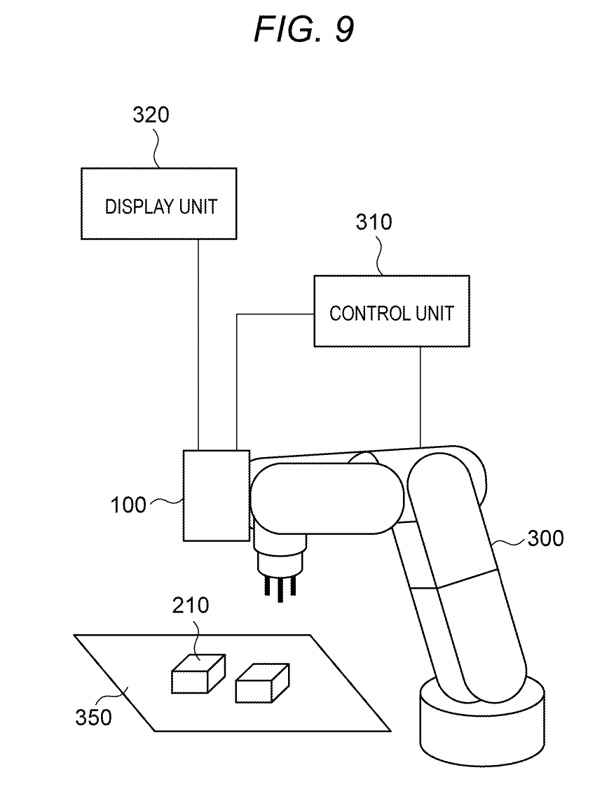

The above-mentioned recognition apparatus can be used in a state of being supported by a certain support member. In the embodiment, a system including a robot arm 300 (also simply referred to as the robot or holding apparatus), and a recognition apparatus 100 supported by (provided to) the robot arm 300 as in FIG. 9 is described as an example. The recognition apparatus 100 illuminates an object 210 placed on a support base 350, images the object 210, and acquires image data. A processing unit of the recognition apparatus 100, or a control unit 310 that has acquired the image data from the processing unit of the recognition apparatus 100, then acquires (recognizes) at least one of the position and the orientation of the object 210. The control unit 310 acquires information on at least one of the position and the orientation. The control unit 310 transmits a driving command to the robot arm 300 based on the information (the recognition result) to control the robot arm 300. The robot arm 300 holds the object 210 with, for example, a robot hand (a holding unit) at a distal end of the robot arm 300, and moves the object 210 by translation, rotation, or the like. Furthermore, the object 210 is assembled by the robot arm 300 to another object (such as a component). Accordingly, an article including a plurality of objects (such as components), for example, an electronic circuit board or machine, can be manufactured. Moreover, the object 210 moved by the robot arm 300 is processed. Accordingly, an article can be manufactured. The process can include at least one of, for example, processing, cutting, transport, assembly (mounting), inspection, and selection. The control unit 310 can include an arithmetic unit such as a CPU and a storage such as memory. The control unit that controls the robot may be provided to the outside of the control unit 310. Moreover, the image data obtained by and data recognized by the recognition apparatus 100 may be displayed on a display unit 320 such as a display. The article manufacturing method of the embodiment is beneficial in at least one of the performance, quality, productivity, and manufacturing cost of an article as compared to the conventional method.

### Other Embodiments

The aspect of the embodiments is achieved by executing the following process. In other words, it is a process in which software (a program) that achieves the functions of the above-mentioned embodiments is supplied to a system or apparatus via a network or various storage media, and a computer (for example, CPU or MPU) of the system or apparatus reads and executes the software.

Up to this point the several embodiments of the disclosure have been described. It is needless to say that the disclosure is not limited to the embodiments, and various modifications and changes can be made within the scope of the gist of the disclosure.

According to the aspect of the embodiments, it is possible to provide a recognition apparatus that can determine, for example, a condition on at least one of illumination and imaging of an object, the condition being beneficial to recognize at least one of the position and the orientation of the object.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2016-218160, filed Nov. 8, 2016, which is hereby incorporated by reference herein in its entirety.

What is claimed is:

1. An apparatus that recognizes one of a position and an orientation of an object, the apparatus comprising:
an acquisition unit configured to illuminate the object, image the illuminated object, and acquire image data of the object; and
a processing unit configured to acquire the one of the position and the orientation of the object based on a first degree of correlation between the image data and reference data of the one of the position and the orientation, wherein
the processing unit determines a condition on one of the illumination and the imaging based on a second degree of correlation between the image data and the reference data.

2. The apparatus according to claim 1, further comprising an input unit configured to input information on the one of the position and the orientation,
wherein the processing unit generates the reference data based on the input information.

3. The apparatus according to claim 1, wherein the first degree of correlation and the second degree of correlation, which are used by the processing unit, are the same degree of correlation.

4. The apparatus according to claim 1, wherein the processing unit obtains a degree of correlation of edge information included in the image data, as the second degree of correlation.

5. The apparatus according to claim 1, wherein the processing unit obtains a degree of correlation related to distance information included in the image data, as the second degree of correlation.

6. The apparatus according to claim 1, wherein the processing unit obtains the second degree of correlation based on features of the image data and features of the reference data.

7. The apparatus according to claim 6, wherein the processing unit obtains the second degree of correlation based on a difference between the features of the image data and the features of the reference data.

8. The apparatus according to claim 1, wherein the processing unit acquires shape data representing a shape of the object, and generates the reference data based on the shape data.

9. The apparatus according to claim 1, wherein the processing unit acquires shape data related to the object, the shape data having been obtained by computer-aided design or shape measurement, and generates the reference data based on of the shape data.

10. The apparatus according to claim 1, wherein the processing unit determines, as the condition, a condition on one of intensity of the illumination, time of the imaging, and amplification of a signal in the imaging.

11. A system comprising:
an apparatus that recognizes one of a position and an orientation of an object, the apparatus comprises:
an acquisition unit configured to illuminate the object, image the illuminated object, and acquire image data of the object; and
a processing unit configured to acquire one of the position and the orientation of the object based on a first degree of correlation between the image data and reference data of one of the position and the orientation,
wherein the processing unit determines a condition on one of the illumination and the imaging based on a second level of correlation between the image data and the reference data; and
a robot configured to hold and move the object based on a recognition result by the apparatus.

12. The system according to claim 11, wherein the processing unit obtains a degree of correlation related to edge information included in the image data, as the second degree of correlation.

13. The system according to claim 11, wherein the processing unit obtains a degree of correlation related to distance information included in the image data, as the second degree of correlation.

14. The system according to claim 11, wherein the processing unit obtains the second degree of correlation based on features of the image data and features of the reference data.

15. A method comprising:
recognizing an object including one of a position and an orientation of the object;
illuminating the object, imaging the illuminated object, and acquiring image data of the object;
acquiring the one of the position and the orientation of the object based on a first degree of correlation between the image data and reference data of the one of the position and the orientation;
determining a condition on the one of the illumination and the imaging based on a second level of correlation between the image data and the reference data; and
processing the object recognized in the above recognition.

16. The method according to claim 15, further comprising obtaining a degree of correlation related to edge information included in the image data, as the second degree of correlation.

17. The method according to claim 15, further comprising obtaining a degree of correlation related to distance information included in the image data, as the second degree of correlation.

18. The method according to claim 15, further comprising obtaining the second degree of correlation based on features of the image data and features of the reference data.

19. A method for determining a condition on one of illumination and imaging for illuminating an object, imaging the illuminated object, acquiring image data of the object, and recognizing one of a position and an orientation of the object based on a first degree of correlation as a degree of correlation between the image data and reference data related to the one of the position and the orientation, the method comprising:
determining the condition based on a second degree of correlation as a degree of correlation between the image data and the reference data.

20. The method according to claim 19, further comprising inputting information on the one of the position and the orientation; and
generating the reference data based on the input information.
